(19) United States
(12) Patent Application Publication
(10) Pub. No.: US 2012/0152629 A1
(43) Pub. Date: Jun. 21, 2012

(54) HYDRAULIC SYSTEM HAVING LOAD LOCK VALVE

(76) Inventors: Daniel T. MATHER, Lockport, IL (US); Daryl J. Belshan, Plainfield, IL (US)

(21) Appl. No.: 13/271,971

(22) Filed: Oct. 12, 2011

Related U.S. Application Data
(60) Provisional application No. 61/423,303, filed on Dec. 15, 2010.

(51) Int. Cl. B62D 5/08; B62D 12/00; B62D 61/10; F16K 1/00; F15D 1/00

(52) U.S. Cl. 180/22; 251/321; 137/565.01

(57) ABSTRACT

A load lock valve for a hydraulic system is disclosed. The load lock valve may have a block with a first bore, and a body disposed within the first bore. The body may have a second bore, and first and second first radial ports in fluid communication with the second bore. The body may also have a valve seat, and a poppet disposed within the body. The poppet may have a nose end, a control end, a balance passage extending from the control end toward the nose end and terminating short of the nose end, and a third radial port in fluid communication with the balance passage. The load lock valve may further have a spring configured to bias the poppet toward the first opening. The control end of the poppet is fluidly communicated with the first radial port when a sealing surface at the nose end is against the valve seat.

### RELATED APPLICATIONS

This application is based on and claims the benefit of priority from U.S. Provisional Application No. 61/423,303 by Daniel T. MATHER et al., filed Dec. 15, 2010, the contents of which are expressly incorporated herein by reference.

### TECHNICAL FIELD

The present disclosure relates generally to a hydraulic system, and more particularly, to a hydraulic system having a load lock valve.

### BACKGROUND

Motor graders are commonly used in earth leveling applications such as road maintenance or surface contouring, where the motor graders are required to follow a defined course while scraping a work tool such as a blade or a ripper against a work surface to remove material from the work surface. A motor grader typically has a front frame containing a front axle with steerable wheels, and a rear frame containing tandem rear axles with non-steerable and driven wheels. The front frame is connected to the rear frame by an articulation joint. Steering of a motor grader is accomplished by pivoting the front wheels relative to the front axle, by actuating articulation cylinders located on either side of the articulation joint to pivot the front frame relative to the rear frame, or by both pivoting the front wheels and articulating the front frame at the same time.

When steering by turning the front wheels while simultaneously articulating the front frame, overrunning loads can be induced within the articulation cylinders that cause voiding of the cylinders. That is, the articulation cylinders, because of steering at the front wheels, could be forced to extend or retract faster than normally possible by articulation steering alone. This overrunning condition can cause a significant pressure differential across the cylinders (voiding) that could damage the cylinders and/or valving associated with the cylinders. For this reason, some articulation cylinders are provided with load lock valves that restrict fluid flows exiting the cylinders to thereby reduce the likelihood of voiding. Unfortunately, it may be possible for these load lock valves to stick and thereby cause undesired instabilities in machine steering and travel.

An example of a load lock valve is disclosed in U.S. Pat. No. 5,960,814 (the '814 patent) issued to Kot on Oct. 5, 1999. Specifically, the '814 patent discloses a load lock valve for use with a hydraulic cylinder of a load handling system. The load lock valve includes a body having a bore therein, a valve stem disposed within the bore, and a relief piston located end-to-end with the valve stem. The valve stem includes a poppet that is spring-biased to engage a seat when a failure of the load handling system causes a loss of pressure at a rod-end of the hydraulic cylinder. When the poppet engages the seat, no fluid from a head-end of the cylinder is allowed to leave the cylinder. The relief piston holds the poppet away from the seat for normal cylinder movement as long as pressurized fluid is directed into the head end of the cylinder. In this manner, during a failure that causes a sudden drop in pressure at the head end of the cylinder, a load previously lifted by the cylinder is kept from lowering until pressure at the head end is restored.

Although the system of the '814 patent may be applicable to a load handling system, it may lack applicability to a steering system. In particular, the load lock valve of the '814 patent may only function during a failure situation and, in response to the failure, may stop all movement of the cylinder. In addition, the load lock valve of the '814 patent may need to be manually reset before the cylinder can again start functioning. Accordingly, the load lock valve of the '814 patent may do little to reduce the likelihood of voiding during a non-failure situation, and may possibly result in the instabilities described above if applied to a steering system.

The hydraulic system of the present disclosure addresses one or more of the needs set forth above and/or other problems of the prior art.

### SUMMARY

In one aspect, the present disclosure is directed to a load lock valve. The load lock valve may include a block having a first bore, and a body disposed within the first bore. The body may include a second bore with a first opening at a first end of the body and a second opening at an opposing second end of the body, a first radial port located at the first end of the body in fluid communication with the second bore, a second radial port located between the first radial port and the second end of the body in fluid communication with the second bore, and a valve seat disposed between the first and second radial ports. The load lock valve may also include a poppet disposed within the body and having a nose end, a control end, a balance passage extending from the control end toward the nose end and terminating short of the nose end, and a third radial port located at the nose end in fluid communication with the balance passage. The load lock valve may additionally include a spring located at the control end and configured to bias the poppet toward the first opening. The control end of the poppet is fluidly communicated with the first radial port when a sealing surface at the nose end is against the valve seat.

In another aspect, the present disclosure is directed to a hydraulic control system. The hydraulic control system may include a tank, a pump configured to draw fluid from the tank and pressurize the fluid, and an actuator having a first chamber and a second chamber and being configured to receive the pressurized fluid and discharge fluid to the tank. The hydraulic control system may also include at least one valve disposed between the actuator and the pump and tank and being configured to selectively allow pressurized fluid into the first and second chambers and out of the first and second chambers to move the actuator, and a load lock valve associated with the first chamber. The load lock valve may include a valve element movable against a spring bias from a flow-blocking position toward a flow passing position, and at least one piston movable by a pressure of fluid discharged from the pump into the second chamber to push the valve element against the spring bias. The valve element may be fluidly communicated at opposing ends with a pressure of fluid passing from the first chamber through the load lock valve.

### BRIEF DESCRIPTION OF THE DRAWINGS

FIG. 1 is a pictorial illustration of an exemplary disclosed machine;

FIG. 2 is a schematic illustration of an exemplary disclosed hydraulic system that may be utilized with the machine of FIG. 1;

FIG. 3 is cross-sectional illustration of an exemplary disclosed valve that may be used with the hydraulic system of FIG. 2; and

FIG. 4 is cross-sectional illustration of another exemplary disclosed valve that may be used with the hydraulic system of FIG. 2.

### DETAILED DESCRIPTION

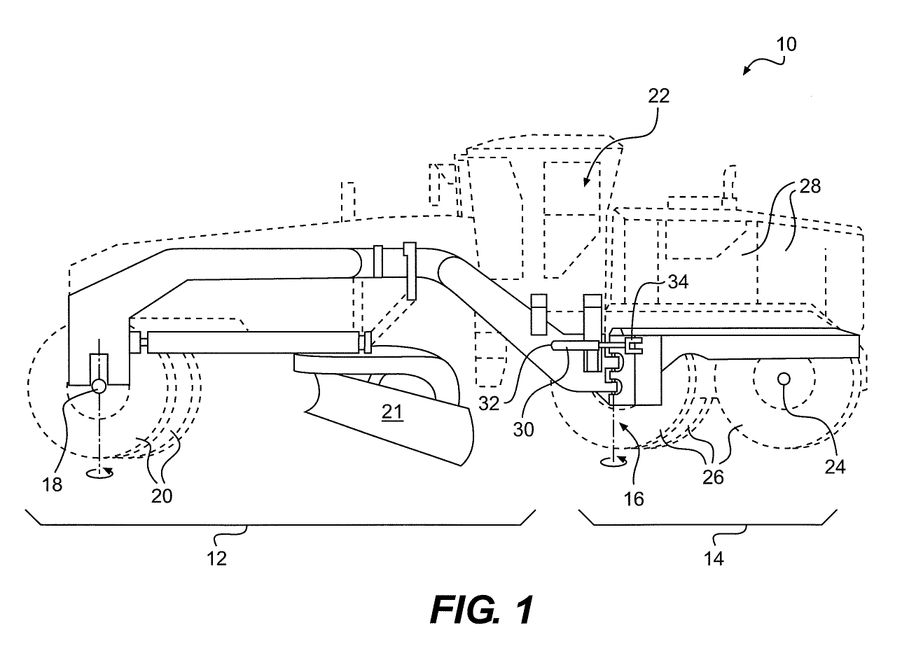

An exemplary embodiment of a machine 10 is illustrated in FIG. 1. Machine 10 may be, for example, a motor grader, a wheel loader, a haul truck, or any other type of machine known in the art. Machine 10 may include a front frame 12, and a rear frame 14 connected to front frame 12 by an articulation joint 16. Front frame 12 may include a front axle 18 having pair of pivotal front wheels 20 and be configured to support a work tool 21 and an operator station 22. Rear frame 14 may include tandem rear axles 24 (only one shown) having pivotally fixed rear wheels 26 and be configured to support compartments 28 for housing an engine (not shown) and associated cooling components (not shown). The engine may be operatively coupled to drive rear wheels 26 for primary propulsion of machine 10 and supply power used for steering machine 10. Steering of machine 10 may be a function of both front wheel pivoting and articulation of front frame 12 relative to rear frame 14 about articulation joint 16.

One or more hydraulic actuators 30 may be associated with machine 10 to facilitate articulation of front frame 12 relative to rear frame 14. In the disclosed embodiment, two substantially identical hydraulic actuators 30 are associated with machine 10 and disposed in opposition to each other at the sides of articulation joint 16. Each of hydraulic actuators 30 may be attached at a head end 32 to front frame 12 and at a rod end 34 to rear frame 14. To articulate front frame 12 in a counterclockwise direction relative to rear frame 14 (as viewed from above machine 10), the hydraulic actuator 30 located at the left side of machine 10 (as viewed from an operator's perspective) may be retracted to bring the corresponding head and rod ends 32, 34 closer together, while at the same time the hydraulic actuator 30 located at the right side of machine 10 may extend to push the corresponding head and rod ends 32, 34 farther apart.

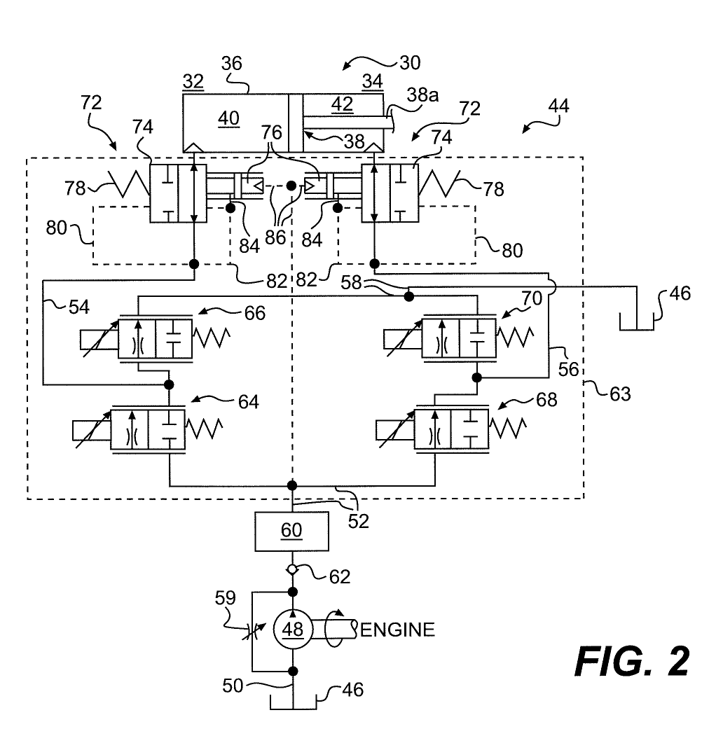

As shown in FIG. 2, each of hydraulic actuators 30 (only one shown) may include a tube 36 and a piston assembly 38 arranged to form a head-end pressure chamber 40 and a rod-end pressure chamber 42. In one example, a rod portion 38a of piston assembly 38 may extend through rod-end pressure chamber 42. It is contemplated that a similar rod portion (not shown) may also extend through head-end chamber 42, if desired. Rod-end pressure chamber 42 may be associated with rod-end 34 of hydraulic actuator 30, while head-end pressure chamber 40 may be associated with the opposing head end 32.

Head- and rod-end pressure chambers 40, 42 may each be selectively supplied with pressurized fluid and drained of the pressurized fluid to cause piston assembly 38 to displace within tube 36, thereby changing an effective length of hydraulic actuators 30. A flow rate of fluid into and out of head- and rod-end pressure chambers 40, 42 may relate to a velocity of hydraulic actuators 30, while a pressure differential between head- and rod-end pressure chambers 40, 42 may relate to a force imparted by hydraulic actuators 30 on the associated frame members.

Machine 10 may include a hydraulic control system 44 having a plurality of fluid components that cooperate to cause the extending and retracting movements of hydraulic actuators 30 described above. Specifically, hydraulic control system 44 may include a tank 46 holding a supply of fluid, and a source 48 configured to pressurize the fluid and direct the pressurized fluid to each of hydraulic actuators 30. Source 48 may be connected to tank 46 via a tank passage 50, and to each hydraulic actuator 30 via a common supply passage 52 and separate head- and rod-end passages 54, 56. Tank 46 may be connected to each hydraulic actuator 30 via a common drain passage 58 and head- and rod-end passages 54, 56. Hydraulic control system 44 may also include a plurality of valves located between hydraulic actuators 30 and tank 46 and source 48 to regulate flows of fluid through passages 52-58.

Source 48 may be configured to draw fluid from one or more tanks 46 and pressurize the fluid to predetermined levels. Specifically, source 48 may embody a pumping mechanism such as, for example, a variable displacement pump having a displacement actuator that adjusts a displacement thereof based on a pressure of hydraulic control system 44, a fixed displacement pump (shown in FIG. 2) having an unloader valve 59 that selectively reduces a load on source 48, or any other type of source known in the art. Source 48 may be directly connected to the engine of machine 10 by, for example, a countershaft (not shown), a belt (not shown), an electrical circuit (not shown), or in any other suitable manner. Alternatively, source 48 may be indirectly connected to the engine via a torque converter, a reduction gear box, an electrical circuit, or in another manner known in the art.

In one embodiment, a pressure compensating valve 60 and/or a check valve 62 may be disposed within common supply passage 52 downstream of source 48 to provide a unidirectional supply of fluid having a substantially constant flow from source 48 into the passages of hydraulic control system 44. It is contemplated that, in some applications, pressure compensating valve 60 and/or check valve 62 may be omitted, if desired.

Tank 46 may constitute a reservoir configured to hold a low-pressure supply of fluid. The fluid may include, for example, a dedicated hydraulic oil, an engine lubrication oil, a transmission lubrication oil, or any other fluid known in the art. One or more hydraulic systems within machine 10 may draw fluid from and return fluid to tank 46. It is contemplated that hydraulic control system 44 may be connected to multiple separate fluid tanks or to a single tank, as desired.

The valves of hydraulic control system 44 may be disposed within a valve block 63 and include, for example, a head-end supply valve 64, a head-end drain valve 66, a rod-end supply valve 68, and a rod-end drain valve 70. Head-end supply valve 64 may be disposed between common supply passage 52 and head-end passage 54, which may lead to head-end pressure chamber 40 of hydraulic actuator 30. Head-end drain valve 66 may be disposed between head-end passage 54 and common drain passage 58. Rod-end supply valve 68 may be disposed between common supply passage 52 and rod-end passage 56, which may lead to rod-end pressure chamber 42. Rod-end drain valve 70 may be disposed between rod-end passage 56 and common drain passage 58. Each of valves 64-70 may include a variable-position, spring-biased valve element, for example a poppet or spool element, that is solenoid actuated and configured to move to any position between a first end-position at which fluid is allowed to flow through the respective valve, and a second end-position at which fluid flow is blocked.

It is contemplated that one or more of valves 64-70 may include a different number and/or type of elements than described above such as, for example, a fixed-position valve element and/or a valve element that is hydraulically actuated, mechanically actuated, pneumatically actuated, or actuated in another suitable manner. It is further contemplated that some or all of valves 64-70 may be combined and include a fewer number of valve elements, as desired. For example a single spool valve (not shown) may be utilized to regulate all head-end flows associated with hydraulic actuator 30, while another spool valve (not shown) may be utilized to regulate all rod-end flows. In another example, a single spool valve (not shown) may be utilized to regulate all head- and rod-end flows associated with hydraulic actuators 30. It is yet further contemplated that valves 64-70 may be associated with only one of hydraulic actuators 30, or that valves 64-70 may be common to both of hydraulic actuators 30, as desired. When control valves 64-70 are common to both of hydraulic actuators 30, each supply valve (i.e., head-end or rod-end supply valves 64, 68) and each drain valve (i.e., head-end or rod-end drain valves 66, 70) may be associated with head-end pressure chamber 40 of one hydraulic actuator 30 and rod-end pressure chamber 42 of the other hydraulic actuator 30, such that when a particular chamber of one hydraulic actuator 30 is filling, the same chamber of the other hydraulic actuator 30 is draining and vice versa.

As described above, when machine 10 is steered via simultaneous wheel turning and frame articulation, an overrunning condition may be generated that causes voiding of hydraulic actuator 30. For the purposes of this disclosure, the overrunning condition may be considered the condition that exists when piston assembly 38 of hydraulic actuator 30 is mechanically forced to move in a particular direction faster than possible through normal fluid supply to the expanding chamber of hydraulic actuator 30. When piston assembly 38 is moved faster than normally possible, piston assembly 38 may mechanically force one of head- or rod- chambers 40, 42 to contract and discharge fluid at a very high-pressure, while simultaneously drawing down the pressure of the expanding chamber to a very low level (e.g., while creating a near vacuum in the expanding chamber). As piston assembly 38 is forced to move faster by the mechanical interactions of machine 10 during steering, a low-pressure threshold within the expanding chamber of hydraulic actuator 30 will eventually be crossed that could result in damage to hydraulic actuator 30. This state is known as voiding.

To help reduce the likelihood of voiding during the overrunning condition, hydraulic actuator 30 may be provided with a set of load lock valves 72. In particular, a first or head-end load lock valve 72 may be associated with head-end pressure chamber 40 of hydraulic actuator 30, while a second substantially identical load lock valve 72 (i.e., a rod-end load lock valve 72) may be associated with rod-chamber 42. Each of load lock valves 72 may include a valve element 74 moveable by a piston 76 from a flow-blocking position, against the bias of a spring 78, toward a flow-passing position. When valve element 74 is in the flow-blocking position, flow through the respective head- or rod-end passage 54, 56 may be inhibited. When valve element 74 is in the flow-passing position, flow through the respective head- or rod-end passage 54, 56 may be allowed substantially unimpeded by load lock valve 72. Valve element 74 may be moved to any position between the flow-blocking and flow-passing positions to affect a variable restriction on the flow of fluid through load lock valve 72. The restriction on the flow of fluid through load lock valve 72 may function to limit the corresponding movement of piston assembly 38 within hydraulic actuator 30. By limiting the movement of piston assembly 38 during the overrunning condition, source 48 can supply pressurized fluid into the expanding chamber of hydraulic actuator 30, thereby reducing the likelihood of voiding therein. In this manner, regardless of the direction of machine steering (i.e, regardless of whether hydraulic actuators 30 are extending or retracting), both head- and rod-end pressure chambers 40, 42 of each hydraulic actuator 30 may be protected from voiding by its associated load lock valve 72 during over-running loads.

A plurality of pilot passages may be associated with valve element 74 and piston 76. In particular, a first pilot passage 80 of each load lock valve 72 may direct fluid pressure from a corresponding one of head- or rod-end passages 54, 56 at a side of each load lock valve 72 opposite hydraulic actuator 30 (i.e., from an upstream side if the associated chamber is expanding or from a downstream side if the associated chamber is contracting) to push on a spring-end of each valve element 74. Simultaneously, a second pilot passage 82 may direct fluid from the same location within the corresponding one of head- or rod-end passages 54, 56 to push on an end of each valve element 74 opposite spring 70. First and second pilot passages 80, 82 may together substantially hydraulically balance valve element 74 (i.e., first and second pilot passages 80, 82 may function as balance passages for valve element 74). A third pilot passage 84 in each load lock valve 72 may also communicate fluid from second pilot passage 82 to an internal end of piston 76 and thereby urge piston 76 away from the associated valve element 74. A fourth pilot passage 86 may extend from common supply passage 52 to distal ends of each piston 76 and thereby urge pistons 76 toward the associated valve elements 74. It is contemplated that fourth pilot passage 86 may be omitted in some situations, as will be explained in greater detail below.

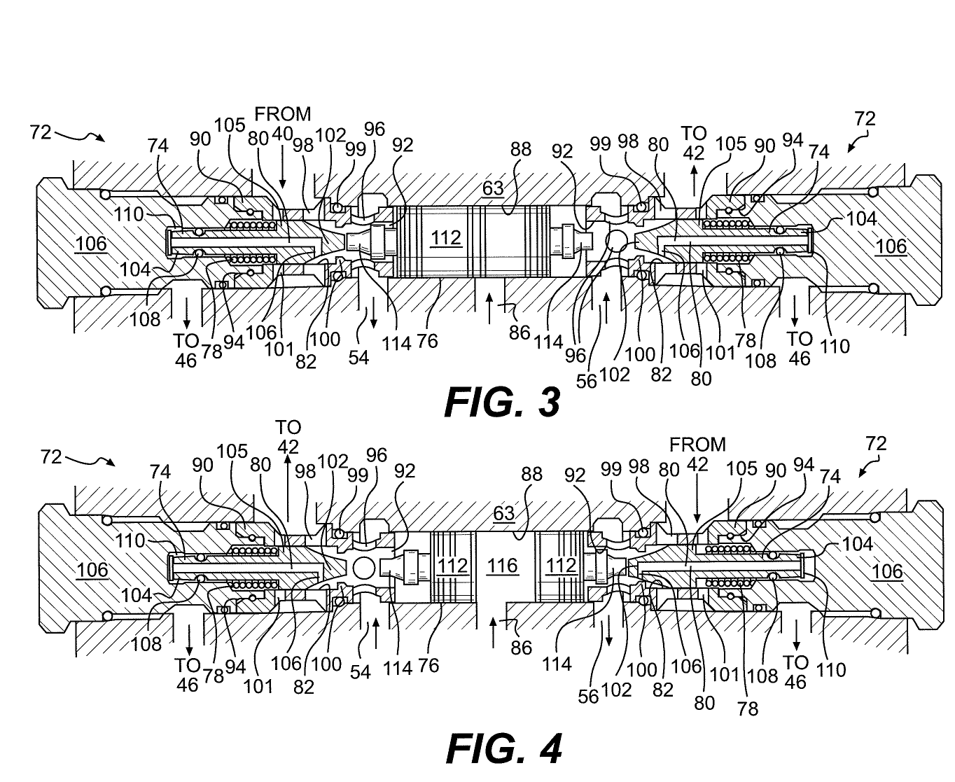

The cross-sections of FIGS. 3 and 4 show exemplary physical embodiments of load lock valves 72. As shown in FIGS. 3 and 4, valve block 63 may include a first bore 88 configured to receive a body or cage 90 of each load lock valve 72 and associated springs 78. Second pilot passage 82 may be formed as a second bore within each body 90 that receives valve element 74 and includes a first opening 92 at a first end and a second opening 94 at a second opposing end near spring 78. A first radial port 96 formed at the first end of body 90 and a second radial port 98 formed between first radial port 96 and the second end of body 90 may both be in fluid communication with second pilot passage 82. Body 90 may also include an integrally-formed valve seat 100 disposed within second pilot passage 82 between first and second radial ports 96, 98, and a leak port 101 that fluidly communicates spring 78 with tank 46 (referring to FIG. 2). An annular seal 99 may be located on an external surface of body 90, axially between first and second radial ports 96, 98.

Valve element 74, in the embodiments of FIGS. 3 and 4, may be a poppet type of element disposed within second pilot passage 82 of body 90. Valve element 74 may include a tapered or conical nose end 102 having a first cross-sectional area exposed to fluid from first radial port 96, and a blunt control end 104 opposite nose end 102 having a second cross-sectional area smaller than the first cross-sectional area. The larger cross-sectional area at nose end 102 may help to inhibit valve element 74 from becoming hydraulically locked in the flow-blocking position. Spring 78 may be located between nose end 102 and control end 104 to push on shoulders 105 of valve element 74 and thereby urge valve element 74 toward valve seat 100 at first opening 92. First pilot passage 80 may be formed along an interior of valve element 74, from control end 104 toward nose end 102 and terminating short of nose end 102. A third radial port 106 formed at nose end 102 may communicate first pilot passage 80 with second pilot passage 82. In this configuration, when nose end 102 is pushed against valve seat 100 by spring 78, control end 104 may be in fluid communication with first radial port 96 via third radial port 106 and first pilot passage 80 and both first radial port 96 and control end 104 may be substantially isolated from second radial port 98 (see rod-end load lock valve 72 of FIG. 4). A cap 106 may engage first bore 88 of valve block 63 at an end of body 90 to close off second opening 94 of body 90 and to provide a reaction base for spring 78. An annular seal 108 located between valve element 74 and cap 106 at control end 104 may create a sealed chamber 110 within cap 106.

Piston 76, in the embodiment of FIG. 3, may be a common single-piece piston configured to selectively move valve elements 74 of both head- and rod-end load lock valves 72 toward their respective flow-passing positions. In particular, piston 76 may include a body 112 and two opposing end portions 114 connected to body 112. Each end portion 114 may be configured to push on nose end 102 of an associated valve element 74 against the bias of the corresponding spring 78. Fluid pressure from first ports 96 of each load lock valve 72 may communicate with pressure surfaces at each end portion 114 to urge piston 76 in opposing directions based on the pressure of fluid applied to the surfaces.

Piston 76, in the embodiment of FIG. 4, may be associated with only one of load lock valves 72. That is, each of head- and rod-end load lock valve 72 may include its own piston 76 dedicated to moving only its own valve element 74. In this configuration, a space 116 may be maintained between pistons 76 of the different load lock valves 72. Fluid pressure from source 48 may be communicated with space 116, via fourth pilot passage 86, to act on the separate pistons 76 and urge pistons 76 toward their respective valve elements 74.

FIGS. 3 and 4 illustrate exemplary operations of load lock valves 72 during two different conditions. FIGS. 3 and 4 will be discussed in more detail in the following section to further illustrate the disclosed concepts.

### INDUSTRIAL APPLICABILITY

The disclosed load lock valve may be used with any hydraulic system that is operable under overrunning conditions. The disclosed load lock valve may be particularly useful in steering system applications, where varying levels of flow control are beneficial and manual valve resetting is undesired. The disclosed load lock valves may help to reduce instability that tends to occur when acting to increase the restriction to return flow to prevent the potential increase in cylinder speed of an associated actuator during the overrunning condition and thereby reduce the likelihood of voiding. Operation of hydraulic control system 44 will now be explained.

As shown in FIG. 2, hydraulic actuators 30 may be movable by fluid pressure in response to an operator input. In particular, fluid may be drawn from tank 46, pressurized by source 48, and selectively directed to head-end and rod-end supply valves 64, 68. In response to an operator steering input to articulate machine 10, head-end or rod-end supply valves 64, 68 may be moved toward the flow-passing position to direct the pressurized fluid to the appropriate one of head- and rod-end pressure chambers 40, 42. Substantially simultaneously, head-end or rod-end drain valves 66, 70 may be moved toward the flow-passing position to direct fluid from the appropriate one of the head- and rod-end pressure chambers 40, 42 to tank 46 to create a force differential across piston assembly 38 that causes piston assembly 38 to move.

For example, if a retraction of hydraulic actuator 30 is requested, rod-end supply valve 68 may be moved toward the flow-passing position (shown in FIG. 2) to direct pressurized fluid from source 48 to rod-end pressure chamber 42. Substantially simultaneous to the directing of pressurized fluid to rod-end pressure chamber 42, head-end drain valve 66 may also be moved toward the flow-passing position (shown in FIG. 2) to allow fluid from head-end pressure chamber 40 to drain to tank 46. The high-pressure fluid within rod-end pressure chamber 42 and the low-pressure fluid within head-end pressure chamber 40 may together create a force differential across piston assembly 38 that causes piston assembly 38 to move and retract into tube 36. During the retraction of hydraulic actuator 30, head-end supply valve 64 and rod-end drain valve 70 may be maintained in their flow-blocking positions (shown in FIG. 2).

As the pressurized fluid from rod-end supply valve 68 flows toward rod-end pressure chamber 42 via rod-end passage 56 during a normal retraction (i.e., during a non-overrunning retraction), the fluid may enter the rod-end load lock valve 72 (right-most load lock valve 72 shown in FIGS. 2-4) via first radial port 96 (referring to FIG. 3). As shown in FIG. 3, the pressurized fluid from rod-end passage 56 may act on the pressure surface of valve element 74 at nose end 102 and move valve element 74 against the bias of spring 78 toward the flow-passing position. Once valve element 74 of the rod-end load lock valve 72 has been moved to the flow-passing position, the pressurized fluid from rod-end passage 56 may continue into rod-end pressure chamber 42 via second radial port 98 substantially unimpeded. At this same time, the pressurized fluid at nose end 102 of the rod-end load lock valve 72 may also press against piston 76 at the right-most end portion 114 to urge piston 76 leftward against valve element 74 of the head-end load lock valve 72 (left-most load lock valve 72 shown in FIGS. 2-4) and toward the flow-passing position such that fluid from within head-end pressure chamber 40 may drain to tank 46 via passages 54 and 58 substantially unimpeded. A normal extension of hydraulic actuator 30 may be performed in a similar manner and, therefore, will not be described in detail in this disclosure.

During steering of machine 10, when wheels 20 (referring to FIG. 1) are turning and hydraulic actuators 30 are articulating, the wheel turning of machine 10 may force hydraulic actuators 30 to move faster than if articulation was performed alone. This mechanical interaction may result in the overrunning condition of one or both of hydraulic actuators 30. FIG. 4 may illustrate functionality of load lock valve 72 during an overrunning extension of hydraulic actuator 30.

During the overrunning extension of hydraulic actuator 30, the pressure of the fluid discharged from hydraulic actuator 30 may be elevated and, in some situations, exceed the pressure of the fluid entering hydraulic actuator 30. That is, the pressure within rod-end pressure chamber 42 may be greater than the pressure within head-end pressure chamber 40 during the overrunning extension of hydraulic actuator 30. In order to limit the movement of hydraulic actuator 30 and reduce the likelihood of voiding in head-end pressure chamber 40, the rod-end load lock valve 72 may be activated to selectively restrict the flow of fluid exiting rod-end pressure chamber 42.

During a normal extension of hydraulic actuator 30, the pressure of the fluid from source 48 entering head-end pressure chamber 40 and space 116 between pistons 76 may be high enough to move the rod-end piston 76 (right-most piston 76 illustrated in FIG. 4) to the right and push valve element 74 toward the flow-passing position. However, because of the elevated pressure of fluid being discharged from rod-end pressure chamber 42 during the overrunning condition, the fluid passing through the rod-end load lock valve 72 may instead push back against end portion 114 to urge piston 76 leftward and away from valve element 74. As piston 76 is moved away from valve element 74 by the elevated discharge fluid, spring 78 may be free to urge valve element 74 toward the flow-blocking position to restrict the flow of fluid being discharged from rod-end pressure chamber 42. As the pressure of the fluid discharged from rod-end pressure chamber 42 increases by an amount corresponding to a speed of piston assembly 38 (referring to FIG. 1), valve element 74 may be urged farther toward the flow-restricting position to thereby slow the movement of piston assembly 38 even more. As piston assembly 38 slows during the overrunning condition, additional time may be provided for source 48 to supply pressurized fluid to the expanding head-end pressure chamber 40 and reduce the likelihood of voiding therein.

Because valve element 74 may be substantially hydraulically balanced, the likelihood of sticking during the overrunning condition may be reduced. That is, second pilot passage 82, together with third radial port 106, may fluidly communicate both ends of valve element 74 with the same fluid pressure, thereby substantially hydraulically balancing valve element 74 in both the flow-passing and flow-blocking positions. Because valve element 74 may be substantially hydraulically balanced, the likelihood of a pressure differential developing between nose end 102 and control end 104 that causes sticking of valve element 74 may be low. In addition, the larger cross-sectional area at nose end 102, as compared to control end 104, may help ensure that valve element 74 is capable of opening.

It will be apparent to those skilled in the art that various modifications and variations can be made to the hydraulic control system of the present disclosure without departing from the scope of the disclosure. Other embodiments will be apparent to those skilled in the art from consideration of the specification and practice of the hydraulic control system disclosed herein. For example, it is contemplated that, if the single integral piston 76 is used to move valve elements 74 of both load lock valves 72 (as in the embodiment of FIG. 3), fourth pilot passage 86 used to move separate pistons 76 may be omitted, if desired. It is further contemplated that, although the head- and rod-end load lock valves are shown and described as having a common valve block 63, it is contemplated that load lock valves 72 may each include separate and dedicated valve blocks, if desired. It is intended that the specification and examples be considered as exemplary only, with a true scope of the disclosure being indicated by the following claims and their equivalent.

What is claimed is:

1. A load lock valve, comprising:
a block having a first bore;
a body disposed within the first bore and having:
a second bore with a first opening at a first end of the body and a second opening at an opposing second end of the body;
a first radial port located at the first end of the body in fluid communication with the second bore;
a second radial port located between the first radial port and the second end of the body in fluid communication with the second bore; and
a valve seat disposed between the first and second radial ports; and
a poppet disposed within the body and having:
a nose end;
a control end;
a balance passage extending from the control end toward the nose end and terminating short of the nose end; and
a third radial port located at the nose end in fluid communication with the balance passage; and
a spring located at the control end and configured to bias the poppet toward the first opening,
wherein the control end of the poppet is fluidly communicated with the first radial port when a sealing surface at the nose end is against the valve seat.

2. The load lock valve of claim 1, wherein a cross-sectional area at the nose end of the poppet that is exposed to fluid from the first radial port when the sealing surface is against the valve seat is greater than a cross-sectional area at the control end.

3. The load lock valve of claim 2, further including a cap configured to engage the first bore and close off an end of the second bore.

4. The load lock valve of claim 3, further including an annular seal at the control end of the poppet configured to engage the cap and create a sealed chamber within the cap at the control end of the poppet.

5. The load lock valve of claim 2, further including a piston disposed within the first bore and configured to push on the nose end of the poppet against a bias of the spring.

6. The load lock valve of claim 5, wherein the piston includes a first piston surface in fluid communication with fluid from the first radial port, and a second piston surface in fluid communication with source pressure.

7. The load lock valve of claim 6, wherein:
the body is a first body;
the poppet is a first poppet;
the spring is a first spring; and
the load lock valve further includes:
a second body disposed within the first bore and substantially identical to the first body;
a second poppet disposed with the second body and being substantially identical to the first poppet; and
a second spring located at the control end of the second poppet and being substantially identical to the first spring; and
the piston is configured to selectively push on the nose ends of both the first and second poppets against the bias of the first and second springs.

8. The load lock valve of claim 6, wherein:
the body is a first body;
the poppet is a first poppet;
the spring is a first spring;
the piston is a first piston; and
the load lock valve further includes:
a second body disposed within the first bore and substantially identical to the first body;
a second poppet disposed with the second body and being substantially identical to the first poppet;
a second spring located at the control end of the second poppet and being substantially identical to the first spring; and
a second piston disposed within the first bore adjacent and in opposition to the first piston, the second piston being configured to push on the nose end of the second poppet against the bias of the second spring.

9. The load lock valve of claim 1, wherein the third radial port is substantially isolated from the second radial port when the sealing surface at the nose end is against the valve seat.

10. The load lock valve of claim 1, wherein the body further includes a fourth radial port fluidly communicating the spring with the third radial port.

11. The load lock valve of claim 1, further including an annular seal located on an outer surface of the body, between the first and second ports.

12. A hydraulic control system, comprising:
a tank;
a pump configured to draw fluid from the tank and pressurize the fluid;
an actuator having a first chamber and a second chamber and being configured to receive the pressurized fluid and discharge fluid to the tank;
at least one valve disposed between the actuator and the pump and tank and being configured to selectively allow pressurized fluid into the first and second chambers and out of the first and second chambers to move the actuator; and
a load lock valve associated with the first chamber and including:
a valve element movable against a spring bias from a flow-blocking position toward a flow passing position, the valve element being fluidly communicated at opposing ends with a pressure of fluid passing from the first chamber through the load lock valve; and
at least one piston movable by a pressure of fluid discharged from the pump into the second chamber to push the valve element against the spring bias.

13. The hydraulic control system of claim 12, wherein the piston includes:
a first pressure surface in fluid communication with the fluid discharged from the pump into the second chamber; and
a second pressure surface in fluid communication with fluid passing from the first chamber through the load lock valve.

14. The hydraulic control system of claim 12, wherein the load lock valve is configured to selectively restrict the fluid passing from the first chamber through the load lock valve when a pressure of fluid discharged from the pump into the second chamber is less than the pressure of fluid passing from the first chamber through the load lock valve.

15. The hydraulic control system of claim 12, wherein the load lock valve is a first load lock valve and the hydraulic control system further includes a second load lock valve substantially identical to the first load lock valve and associated with the second chamber.

16. The hydraulic control system of claim 15, wherein the at least one piston is configured to selectively push the valve element of both the first and second load lock valves against the spring bias.

17. The hydraulic control system of claim 15, wherein the at least one piston includes:
a first piston associated with the first load lock valve; and
a second piston associated with the second load lock valve and disposed adjacent and in opposition to the first piston.

18. The hydraulic control system of claim 17, further including a pilot passage extending from the pump to a space between the first and second pistons.

19. The hydraulic control system of claim 12, further including a pressure compensating valve located between the pump and the at least one valve.

20. A machine, comprising:
a front section having a steerable front axle;
a rear section having tandem non-steerable rear axles;
an articulation joint connecting the front section to the rear section;
an engine supported by the rear section;
a pump driven by the engine to pressurized fluid;
a cylinder extending between the front and rear sections at the articulation joint and having a head-end and a rod-end selectively filled with and drained of pressurized fluid from the pump to pivot the front section relative to the rear section; and
first and second load lock valves associated with the head-end and rod-end chambers of the cylinder and configured to selectively restrict fluid discharge from the cylinder during simultaneous steering of the front axle and pivoting of the front section relative to the rear section, each of the first and second load locks including a main poppet having:
a valve element movable against a spring bias from a flow-blocking position toward a flow passing position, the valve element being fluidly communicated at opposing ends with a pressure of fluid discharged from the cylinder through the load lock valve; and
at least one piston movable by a pressure of fluid discharged from the pump to push the valve element against the spring bias.
